(19) United States
(12) Patent Application Publication
(10) Pub. No.: US 2024/0000647 A1
(43) Pub. Date: Jan. 4, 2024

(54) TRIANGLE NECK STRETCH THERAPEUTIC EXERCISE DEVICE AND METHOD

(71) Applicants: BING CHEN, ARLINGTON, TX (US); SUMMER CHEN, ARLINGTON, TX (US)

(72) Inventors: BING CHEN, ARLINGTON, TX (US); SUMMER CHEN, ARLINGTON, TX (US)

(21) Appl. No.: 17/855,457

(22) Filed: Jun. 30, 2022

(51) Int. Cl. A61H 1/00; A63B 23/025; A61H 1/02

(52) U.S. Cl. CPC A61H 1/008; A63B 23/025; A61H 1/0296

(57) ABSTRACT

A therapeutic neck exercise device for neck pain relief and stiff neck treatment, includes a back plate, two shoulder belts, and two bottom belts. The two shoulder belts and the two bottom belts are selectively coupled to the back plate. The device helps relieve the user's neck pain when stretching the head backward and stretching the shoulders forward. The stretching position is held for a period of time and then subsequently relaxed. The back plate contacts the upper back of the user. The user's hands push forward on the belts. The user's elbows touch the two bottom belts and push forward and downward. This urges pressure against the upper back of the user and pulls the shoulders forward. While holding the head in a straight position, the user pushes his head backward. This urges proper adjustment of the neck spine and results in decompression of the cervical disc.

### BACKGROUND OF THE INVENTION

### 1. Field of the Invention

The present application relates to therapeutic neck exercise devices, and more particularly to a device for neck pain relief and stiff neck treatment.

### 2. Description of Related Art

Neck pain becomes more common nowadays to people of various ages. Common causes include osteoarthritis, spinal stenosis, herniated disc, pinched nerve, poor posture, tumors and other health conditions.

Various devices have been devised to provide therapeutic exercise for addressing neck problems. A serious limitation of the prior art devices for neck exercise is that they mainly engage with the head of a user and mostly address neck muscle strengthening or increase support of neck and head. There has been no provision in known prior art that provides a neck therapeutic exercise apparatus and methods for directly addressing neck spine misalignment and cervical disc compression.

Although strides have been made, shortcomings remain. It is desired that a device and method be provided that engages a user's head and shoulders, urges proper neck spine adjustment and results in cervical disc decompression.

### BRIEF SUMMARY OF THE INVENTION

It is an object of the present application to provide an exercise device for neck pain relief and stiff neck treatment. The invention includes a back plate, two shoulder belts and two bottom belts. The two shoulder belts are connected to the upper edges of the back plate. The two bottom belts are connected to the bottom edges of the back plate. Each shoulder belt has two ends: one end connects to the upper edges of the back plate, the other end links to one end of bottom belts. Each bottom belt has two ends: one end connects to the bottom edge of the back plate, the other end links to one end of a shoulder belt. The position for the linkage between the shoulder belt and the bottom belt should be adjustable.

It is a further object of the present application that the invention contacts the user's on the upper back and in both shoulders. The two shoulder belts come across the user's two shoulders and extend to the front of the user and link to the two bottom belts. The two bottom belts come across below user's arms and extend to the front of the user and link to the two shoulder belts. User can adjust the position for the linkage of the shoulder belt and bottom belt if needed.

A further object is to provide a method of use to relieve pain and provide treatment. In operation, the user's left hand holds the left side belt and pushes it forward. The user's right hand holds the right side belt and pushes it forward. The user's left elbow touches the left bottom belt and pushes it forward and downward. The user's right elbow touches the right bottom belt and pushes it forward and downward. When user's hands and elbows push forward and downward, the shoulder belts and bottom belts pull the back plate against user's upper back and urge the user's shoulders to stretch forward. While holding his head in a straight position, user stretches his head backward and holds this position for a period of seconds (i.e. 10 to 30 seconds). The user then releases his head, hands and elbows and relaxes. This motion properly adjusts user's neck spine and relieve the neck pain.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a rear perspective view of a medical device according to an embodiment of the present application.

FIG. 2 is a rear view of the medical device of FIG. 1 as worn by a user.

FIG. 3 is a front view of the medical device of FIG. 2.

FIG. 4 is a right perspective view of the medical device of FIG. 2 as worn by the user.

FIG. 5 is a left perspective view of the medical device of FIG. 4.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the medical device of the present application includes a plurality of straps or belts that are coupled together in a manner to allow a user the ability to perform stretching and realignment of the neck area of the body. The plurality of belts are configured to permit wrapping around an upper body of the user so as to wrap under the arms and above the shoulders. Application of pressure by the user on the belts results in pressure being applied to an area of the back and/or neck of the user so as to relieve pain and provide treatment. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

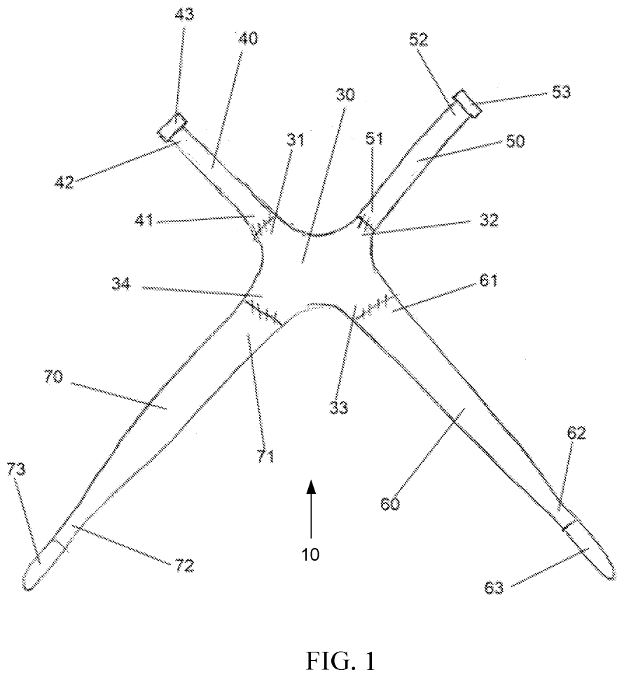

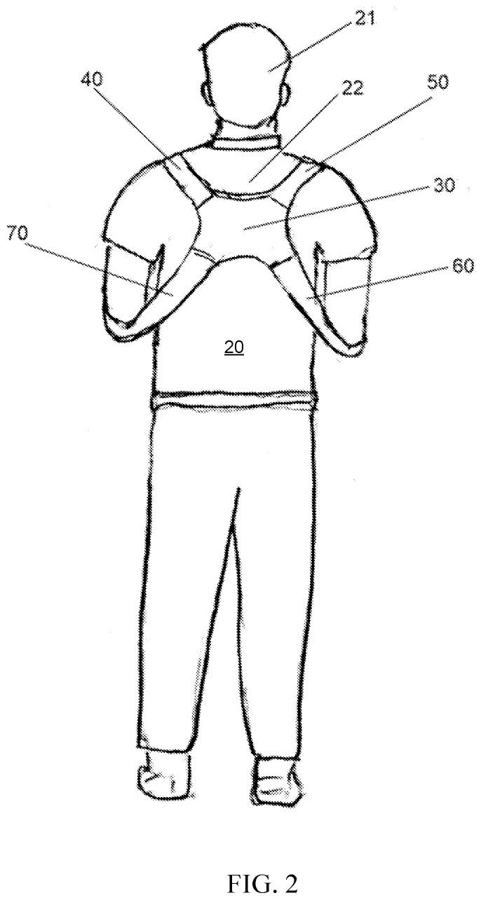

Referring now to FIG. 1 in the drawings, a rear perspective view of the medical device is illustrated. The present invention is a device (10) for neck pain relief and stiff neck treatment in a user (20) (see FIG. 2). Device (10) includes one back plate (30), including one left upper edge (31), one right upper edge (32), one left bottom edge (34) and one right bottom edge (33). Device (10) further includes two shoulder belts. One end (41) of the left shoulder belt (40) connects to the left upper edge (31) of back plate. The other end (42) includes a connection kit (43) for connecting to the left bottom belt (70). One end (51) of the right shoulder belt (50) connects to the right upper edge (32) of the back plate. The other end (52) includes a connection kit (53) for connecting to the right bottom belt (60). The invention includes two bottom belts. One end (71) of the left bottom belt (70) connects to the left bottom edge (34) of the back plate. The other end (72) includes a connection kit (73) for connecting to the left shoulder belt (40). One end (61) of the right bottom belt connects to the right bottom edge (33) of the back plate. The other end (62) includes a connection kit (63) for connecting to the right shoulder belt (50). The two bottom belts are big enough to hold and support user's two elbows. The right bottom belt (60) can hold and support user's right elbow (26). The left bottom belt (70) can hold and support user's left elbow (24).

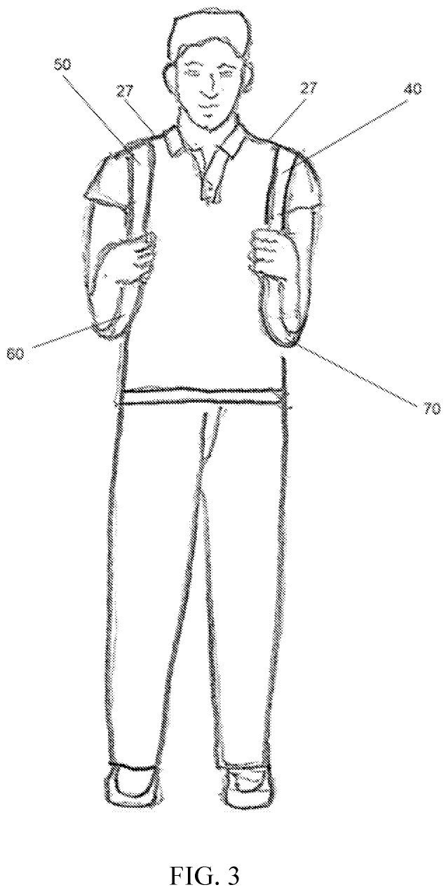

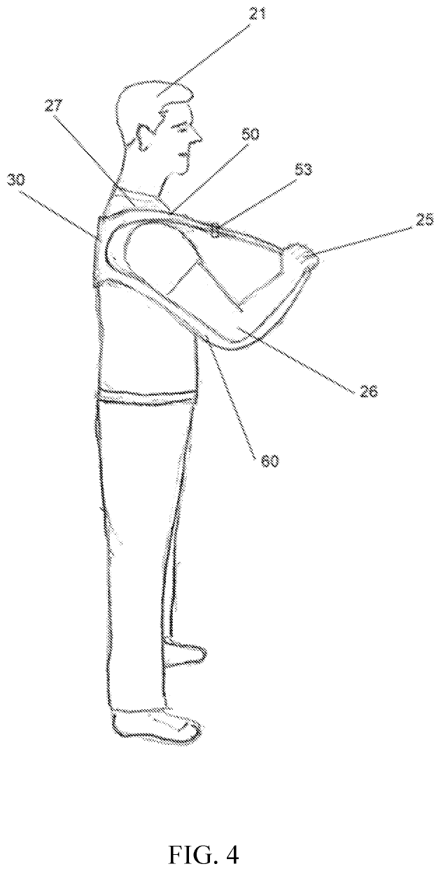

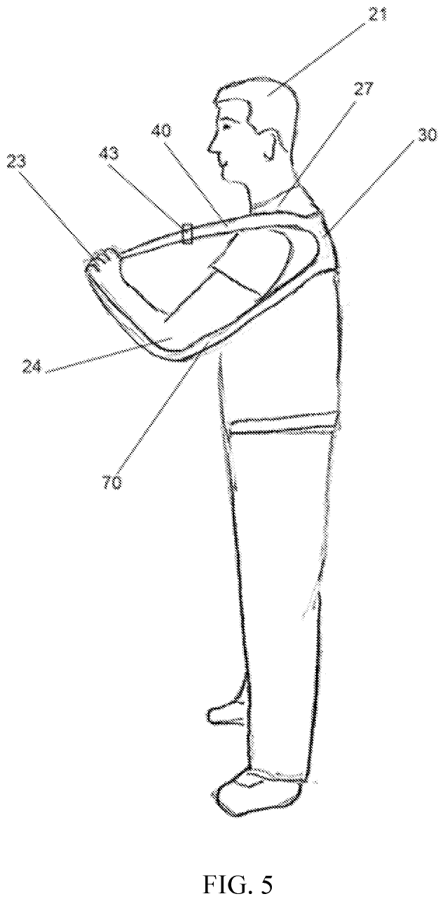

Referring now also to FIGS. 2-5 in the drawings, various views of user (20) wearing and using device (10) are provided. In FIGS. 2-3 the user is at rest with device (10) while in FIGS. 4-5, the user is exerting forces upon device (10) to perform one or more therapeutic stretches.

FIG. 4 illustrates a right perspective view of the device worn by the user. The connection kit (53) on the right shoulder belt (50) connects to the right bottom belt (60) to form a circular shape. The connection kit (63) on right bottom belt (60) connects to the right shoulder belt (50) to form a circular shape. The position for connection between connection kit (53) and connection kit (63) is adjustable. User adjusts the connection position to fit his right hand (25) and right elbow (26). It is understood that many known methods of coupling are possible. A feature of device (10) is that the manner of connection allows the ability to adjust the position or connection point so as to lengthen or shorten the relative loop created therein.

FIG. 5 illustrates a left perspective view of the device worn by the user. The connection kit (43) on left shoulder belt (40) connects to the left bottom belt (70) to form a circular shape. The connection kit (73) on left bottom belt (70) connects to the left shoulder belt (40) to form a circular shape. The position for connection between connection kit (43) and connection kit (73) is adjustable. User adjusts the connection position to fit his left hand (23) and left elbow (24). User adjusts the position of his two hands between the height of his shoulders and elbows as seen in FIG. 3.

The user's left hand (23) holds the left side belt (40) and pushes it forward. The user's left elbow (24) touches the left bottom belt (70) and pushes it forward and downward (FIG. 5). The user's right hand (25) holds the right side belt (50) and pushes it forward. the user's right elbow (26) touches the right bottom belt (60) and pushes it forward and downward (FIG. 4). The shoulder belts and bottom belts pull the back plate against user's upper back (22) (FIG. 2) and urge his shoulders (27) to stretch forward. The user (20) keeps his head (21) straight and stretches his head (21) backward. The user (20) holds this position for period of seconds (10 to 30 seconds). Afterwards, the user releases his head, hands and elbows and relaxes. This motion properly adjusts user's neck spine and relieve the neck pain.

A feature of device (10) is that the manner of connection between the belts to form the loop allows the ability to adjust the position or connection point so as to lengthen or shorten the relative loop created therein. Additionally it should be understood that manipulation of the user's neck and overall posture may influence the effectiveness and area of focus for the treatments. Other methods of treatment may be possible beyond what has been described herein and such disclosure here should not be interpreted as being limiting.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A therapeutic neck exercise device for neck pain relief and stiff neck treatment, comprising:
a back plate;
two shoulder belts; and
two bottom belts;
wherein the two shoulder belts and the two bottom belts are coupled to the back plate.

2. The device of claim 1, wherein the two shoulder belts are coupled to upper edges of the back plate, one on the left side, the other on the right side.

3. The device of claim 1, wherein the two bottom belts are connected to bottom edges of the back plate, one on the left side, the other on the right side.

4. The device of claim 1, wherein each of the two shoulder belts have opposing ends, one end connects to an upper edge of the back plate, the other end configured to couple to an end of the two bottom belts.

5. The device of claim 1, wherein each of the two bottom belts have opposing ends, one end connects to a bottom edge of the back plate, the other end configured to couple to an one end of a shoulder belt.

6. The device of claim 1, further comprising a connecting kit on each of the two shoulder belts.

7. The device of claim 6, wherein each of the connecting kits are configured to couple to an end of one of the bottom belts.

8. The device of claim 7, wherein the position of the tow bottom belts within the connecting kits is adjustable.

9. A method of exercising a user's neck to relieve neck pain and stiff neck treatments, comprising:
obtaining a therapeutic neck exercise device as in claim 1;
locating the back plate about the upper back of the user;
wrapping the two shoulder belts across the user's two shoulders and extend to the front of the user;
linking to the two bottom belts to the two shoulder belts to form a circular shape; and
passing the two bottom belts across and below user's arms and extend to a front of the user and link to the two shoulder belts;
wherein the two bottom belts and the two shoulder belts each form a circular shape when lined together.

10. The method of claim 9, wherein the two bottom belts hold and support the user's two elbows.

11. The method of claim 9, further comprising:
pushing forward on each circular shape with the user's hands, the user's left hand holds a first circular shaped belt link and pushes it forward, the user's right hand holds a second circular shaped belt link and pushes it forward.

12. The method of claim 9, wherein the user's left elbow touches the left bottom belt and pushes it forward and downward; and wherein the user's right elbow touches the right bottom belt and pushes it forward and downward.

13. The method of claim 12, wherein the shoulder belts and bottom belts pull the back plate against the user's upper back and urge the user's shoulders to stretch forward.

14. The method of claim 12, further comprising:
holding the user's head in a straight position; and
stretching the user's head backward.

15. The method of claim 14, further comprising:
holding the position of the user's head for a period of time less than 30 seconds.

16. The method of claim 15, further comprising:
releasing pressure on the two bottom belts and the two shoulder belts and so as to adjust the user's neck and spine.
